(19) United States
(12) Patent Application Publication
(10) Pub. No.: US 2006/0219505 A1
(43) Pub. Date: Oct. 5, 2006

(54) Shock absorber including supplemental friction generating device

(76) Inventor: David Thomas Zdeb, Ypsilanti, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/096,028

(22) Filed: Mar. 31, 2005

(51) Int. Cl. F16F 9/34

(52) U.S. Cl. 188/322.15

(57) ABSTRACT

A shock absorber includes a hydraulic fluid filled cylinder having a cylinder wall and a piston moveably disposed within the cylinder and separating the cylinder into first and second chambers. The piston includes a duct that extends through the piston to provide communication between the first chamber and the second chamber so that hydraulic fluid is free to pass through the piston as the piston moves within the cylinder, at least one piston ring, and a deflectable valve member that cooperates with the duct to regulate fluid flow between the first and second chambers as the piston moves within the cylinder. A friction member is positioned between the piston and the cylinder wall. The friction member is adapted to provide, among other things, a select amount of frictional damping.

### BACKGROUND OF THE INVENTION

1. Field of the Invention

The present invention relates to vehicle shock absorbers including a hydraulic shock absorber having a friction generating device to improve damping properties.

2. Description of the Related Art

Hydraulic shock absorbers for motor vehicles generally include a single piston and oil-filled cylinder arrangement used in combination with a coil spring. A piston rod is connected to the piston within the cylinder with its free end protruding from the cylinder for attachment to the body of a vehicle. The cylinder is attached to the vehicle wheel suspension. Extension or compression of the shock absorber, caused when the wheel suspension passes over a rough surface and elastically deforms the coil spring, is damped by resistance to movement of the piston within the oil-filled cylinder. The damping resistance to movement of the piston may be provided by a valve mechanism on the piston, which restricts the flow of oil from one side of the piston to the other inside within the cylinder. Shock absorbers also exhibit an inherent frictional damping component by virtue of the shock absorber component parts being in physical contact. For example, in a twin-tube style damper, the friction dampening is generated by the rod-to-seal interface, the seal-to-tube interface, and the rod guide-to-rod interface.

Recently, it has been determined that vehicle handling stability during transient maneuvers may be improved by increasing the friction damping component and spring rate of the shock absorber operation. In qualitative terms, the increased friction level in the shock absorber improves handling stability feel of the vehicle, while the spring rate reduces specific road vibration frequencies. These parameters are generally mutually exclusive and prior art shock absorbers have not yet presented a flexible, tunable solution that balances handling stability feel and ride vibration. In one prior art shock absorber, for example, a friction control device is located near the shock absorber seal and rod guide adjacent the top of the shock cylinder. Among other limitations, this configuration significantly increases the amount of friction damping and spring rate, which in some vehicle operating conditions may adversely affect road handling, stability feel, and the amount of ride vibration.

For at least these reasons, and improved shock absorber is desired that overcomes the limitations of the prior art.

### SUMMARY OF THE INVENTION

A shock absorber is provided that includes a hydraulic fluid-filled cylinder having a cylinder wall and a piston moveably disposed within the cylinder and separating the cylinder into first and second chambers. The piston includes a duct that extends through the piston to provide communication between the first chamber and the second chamber so that hydraulic fluid is free to pass through the piston as the piston moves within the cylinder. The piston also includes at least one piston ring and a deflectable valve member that cooperates with the duct to regulate fluid flow between the first and second chambers as the piston moves within the cylinder. A friction member is positioned between the piston and the cylinder wall. The friction member is adapted to provide, among other things, a select amount of frictional damping to the shock absorber operation.

Other aspects of the invention will be apparent to those skilled in the art after review of the drawings and detailed description provided below.

### BRIEF DESCRIPTION OF THE DRAWINGS

Embodiments of the invention will now be described, by way of example, with reference to the accompanying drawings, wherein:

FIG. 1 is a cross-sectional view of a shock absorber according to an embodiment of the present invention; and

FIG. 2 is a detailed view of a portion of the shock absorber shown in FIG. 1.

### DETAILED DESCRIPTION

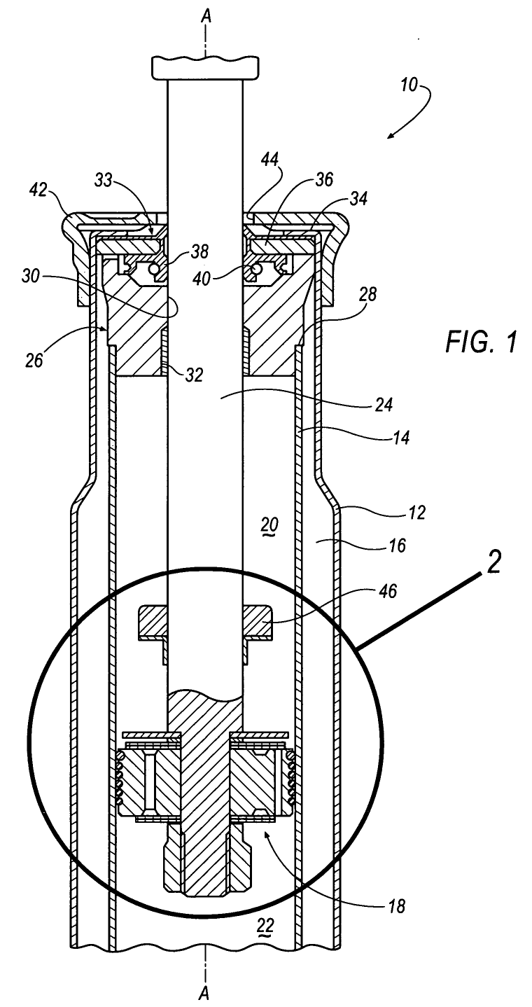

Referring to FIG. 1, a cross-sectional view of a telescopic fluid pressure shock absorber 10 is shown according to an embodiment of the present invention. Shock absorber 10 includes an outer casing 12 that extends along an axis A-A and a hydraulic fluid-filled cylinder 14 contained within outer casing 12 that extends along the same axis. Outer casing 12 and cylinder 14 define a reservoir 16 that may be filled with hydraulic fluid of specified quantity. When equipped as a gas-charged shock absorber, outer casing 12 and/or cylinder 14 may contain pressurized gas, such as nitrogen, to inhibit the formation of gas bubbles (e.g., cavitation) that compromise the incompressibility of the hydraulic fluid.

A piston 18 is moveably disposed within cylinder 14, and separates cylinder 14 into first and second chambers 20 and 22. Piston 18 is attached to a piston rod 24, which together move in a closing direction (compression) and an opening direction (rebound). Although not shown in FIG. 1, piston rod 24 is adapted to be connected or attached to a vehicle suspension component and outer casing 12 is adapted to be connected or attached to the body of the vehicle.

In the illustrated embodiment, a rod guide 26 is positioned at an end 28 of cylinder 14 and includes a bore 30 containing an optional annular bushing 32 that supports sliding movement of piston rod 24. A piston rod seal 33 is positioned between outer casing 12 and piston rod 24 and may be retained between the components, for example, without limitation, by using a flanged end 34 of outer casing 12. In the illustrated configuration, piston rod seal 33 may include an annular retainer 36 and a lip-style sealing member 38 made of a polymeric material, such as rubber, that is affixed to retainer 36. Lip-style seal 38 may be spring energized, as shown in FIG. 1, by a coil spring 40 or other resiliently expandable member. A contoured inner circumferential surface of piston rod seal 33 sealably engages a peripheral surface of piston rod 24 to inhibit leakage of hydraulic fluid from cylinder 14 and the ingression of contaminants, such as dirt and water, into cylinder 14.

A cap 42 covers the flanged end 34 of outer casing 12 and includes an aperture 44 through which piston rod 24 extends. A piston rod stop 46, such as an elastomer-bound piston rod stop, may be secured to piston rod 24 for movement therewith. When so configured, piston rod stop 46 is adapted to engage rod guide 26 to regulate the stroke of piston 18.

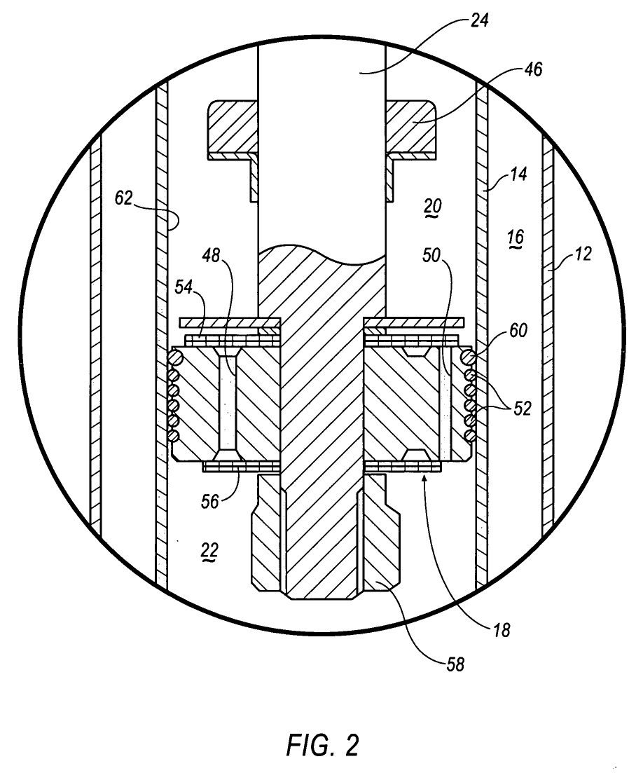

Referring to the detailed illustration shown in FIG. 2, piston 18 includes first and second ducts 48 and 50, which pass through piston 18 generally parallel to axis A-A and provide first chamber 20 in communication with second chamber 22 so that hydraulic fluid is free to pass through piston 18 as the piston moves within cylinder 14. In the illustrated embodiment, piston 18 also includes at least one piston ring 52 and a pair of deflectable, generally disc-shaped valve members 54 and 56 that cooperate with first and second ducts 48, 50 to regulate fluid flow between first and second chambers 20 and 22 as piston 18 moves within cylinder 14. A nut 58 may be used to secure piston 18 and valve members 54, 56 to piston rod 24.

If a differential pressure arises between first and second chambers 20 and 22 as piston 18 moves within cylinder 14, one of valve members 54 or 56 (depending on the direction of fluid flow) will bend and/or transform to form an orifice adjacent a corresponding duct 48 or 50. The level of hydraulic damping provided by shock absorber 10 varies in direct proportion to the velocity of piston 18 and, correspondingly, the velocity of fluid flow through duct 48 or 50 and the size of the resulting orifice created by valve member 54 or 56.

Positioned between piston 18 and cylinder 14 is an annular friction member 60. In an embodiment, friction member 60 is a polymeric (e.g., rubber, plastic, thermoplastic, thermoplastic elastomer or the like) O-ring secured to piston 18 and contacts an inner wall 62 of cylinder 14 to provide a select amount of friction damping and spring rate to the shock absorber operation. As will be appreciated, the level of friction damping and spring rate may be tailored to a particular vehicle application by, for example, modifying the cross-sectional profile and/or material properties of friction member 60. For example, in contrast to the illustrated embodiment shown in FIGS. 1 and 2, friction member 60 may exhibit a non-circular (e.g., rectangular or triangular) cross-sectional profile. Moreover, the resiliency of friction member 60 and/or its coefficient of friction may be modified to achieve the level of friction damping and spring rate desired. It will also be appreciated that the present invention is not limited to the shock absorber design illustrated in FIG. 1 and described above, and that friction member 60 of the present invention may be used in other telescopic fluid pressure shock absorber designs, including those that employ a piston-separated hydraulic fluid chamber configuration.

Unlike prior art shock absorbers that position a supplemental friction device near the shock absorber piston rod seal and rod guide, a friction member 60 according to the present invention may be positioned between cylinder 14 and piston 18. Among other features, providing friction member 60 between cylinder 14 and piston 18 allows the level of friction damping and spring rate to be readily modified without adding considerable structure and cost to the shock absorber construction. Additionally, positioning friction member 60 between cylinder 14 and piston 18 does not reduce the shock absorber bearing span.

Operation of shock absorber 10 will now be discussed with reference to FIGS. 1 and 2. During vehicle maneuvers, undesirable and excess motion in a vehicle body or suspension may be created, among other ways, by the irregularity and/or curvature of the road surface and vehicle braking. This motion forces piston 18 to be displaced relative to cylinder 14. By forcing piston 18 through hydraulic fluid, shock absorber 10 develops the hydraulic friction necessary to resist the undesirable and excess vehicle body or suspension motion. More particularly, the motion applied to piston 18 pressurizes the fluid and forces it to flow through the restricting orifices created by valve members 54, 56, causing the hydraulic fluid to rapidly heat. The thermal energy is transferred to cylinder 14 and outer casing 12, and then harmlessly dissipated to the atmosphere.

As noted above, the damping capacity of shock absorber 10 varies in direct proportion to the velocity of piston 18 and, correspondingly, the velocity of the fluid flow through the piston orifices. However, during transient vehicle maneuvers when the speed with which piston 18 moves in relation to cylinder 14 is relatively low, circulation of hydraulic fluid through the restricting orifices is generally not enough to attenuate undesirable and excess body or suspension motion. To overcome the lack of hydraulic damping during transient vehicle maneuvers, friction member 60 provides a friction force to impart drag on cylinder wall 62 as piston 18 moves relative thereto. The frictional force generated by friction member 60 is generally independent of the piston speed or oscillating input frequency of piston rod 24 and, therefore, improves the vehicle handling and reduces the transmission of road induced suspension vibrations to the vehicle occupants when hydraulic damping is not possible.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A shock absorber, comprising:
a hydraulic fluid-filled cylinder having a cylinder wall;
a piston moveably disposed within the cylinder and separating the cylinder into first and second chambers, the piston including a duct that extends through the piston to provide communication between the first chamber and the second chamber so that hydraulic fluid is free to pass through the piston as the piston moves within the cylinder, at least one piston ring, and a deflectable valve member that cooperates with the duct to regulate fluid flow between the first and second chambers as the piston moves within the cylinder; and
a friction member positioned between the piston and the cylinder wall, the friction member adapted to provide a select amount of friction damping.

2. The shock absorber of claim 1, wherein the friction member comprises a polymeric material.

3. The shock absorber of claim 1, wherein the friction member comprises an elastomeric material.

4. The shock absorber of claim 1, wherein the friction member is annular.

5. The shock absorber of claim 1, wherein the friction member includes an O-ring.

6. The shock absorber of claim 1, wherein the friction member has a generally non-circular cross-section.

7. The shock absorber of claim 1, wherein the friction member is secured to the piston.

8. The shock absorber of claim 1, further including a piston rod attached to the piston and a piston rod guide positioned at an end of the cylinder through which the piston rod extends.

9. The shock absorber of claim 8, wherein the piston rod includes an aperture containing an annular bushing that supports sliding movement of the piston rod.

10. The shock absorber of claim 8, further including a piston rod seal positioned between the piston rod guide and the piston rod.

11. The shock absorber of claim 10, further including an outer casing, the piston rod seal retained between the piston rod guide and the piston rod using a flanged end of the outer casing.

12. The shock absorber of claim 11, further including a cap covering an end of the outer casing and including an aperture through which the piston rod extends.

13. The shock absorber of claim 10, wherein the piston rod seal includes an annular retainer and a sealing member affixed to the retainer.

14. The shock absorber of claim 13, wherein the sealing member is spring energized.

15. The shock absorber of claim 10, wherein a contoured inner circumferential surface of the piston rod seal sealably engages a peripheral surface of the piston rod and is adapted to inhibit leakage of hydraulic fluid from the cylinder and the ingression of contaminants into the cylinder.

16. The shock absorber of claim 8, further including a piston rod stop secured to the piston rod for movement therewith, the piston rod stop adapted to regulate the stroke of the piston.

17. The shock absorber of claim 1, wherein the piston includes first and second ducts that pass through the piston and provide communication between the first chamber and the second chamber so that hydraulic fluid is free to pass through the piston as the piston moves within the cylinder.

18. The shock absorber of claim 17, wherein the piston includes a pair of deflectable valve members that cooperate with the first and second ducts to regulate fluid flow between the first and second chambers as the piston moves within the cylinder.

19. A shock absorber, comprising:
a hydraulic fluid-filled cylinder having a cylinder wall;
a piston moveably disposed within the cylinder and separating the cylinder into first and second chambers, the piston including a duct that extends through the piston to provide communication between the first chamber and the second chamber so that hydraulic fluid is free to pass through the piston as the piston moves within the cylinder, at least one piston ring, and a deflectable valve member that cooperates with the duct to regulate fluid flow between the first and second chambers as the piston moves within the cylinder; and
a friction member including an O-ring secured to the piston and positioned to engage the cylinder wall, the friction member adapted to provide a select amount of friction damping.

20. A shock absorber, comprising:
a hydraulic fluid-filled cylinder;
a piston moveably disposed within the cylinder and separating the cylinder into first and second chambers, the piston including first and second ducts that pass through the piston and provide communication between the first chamber and the second chamber so that hydraulic fluid is free to pass through the piston as the piston moves within the cylinder, at least one piston ring, and a pair of deflectable valve members that cooperate with the first and second ducts to regulate fluid flow between the first and second chambers as piston moves within the cylinder;
a piston rod attached to the piston;
a rod guide positioned at an end of the cylinder that slidingly supports the piston rod;
a piston rod seal positioned between the rod guide and the piston rod, the piston rod seal including an inner circumferential surface sealably engaged with a peripheral surface of the piston rod to inhibit leakage of hydraulic fluid from the cylinder and the ingression of contaminants into the cylinder; and
an annular friction member secured to the piston and contacting the cylinder, the friction member adapted to provide a select amount of friction damping and spring rate to the shock absorber operation.
